(19) United States
(12) Patent Application Publication
(10) Pub. No.: US 2026/0310764 A1
(43) Pub. Date: Oct. 8, 2026

(54) SECURE DIGITAL IDENTITY MANAGEMENT SYSTEM FOR CREATING AND MAINTAINING NON-ATTRIBUTABLE ONLINE PERSONAS

(71) Applicant: Philip Jason Weed, Watkinsville, GA (US)

(72) Inventor: Philip Jason Weed, Watkinsville, GA (US)

(21) Appl. No.: 19/638,592

(22) Filed: Apr. 3, 2026

Related U.S. Application Data
(60) Provisional application No. 63/782,651, filed on Apr. 3, 2025.

(51) Int. Cl. G06F 21/31; G06F 9/455

(52) U.S. Cl. CPC G06F 21/31; G06F 9/45558; G06F 2009/45587; G06F 2009/45595

(57) ABSTRACT

A secure digital identity management system creates and maintains non-attributable online personas for cybersecurity, intelligence, and covert investigative operations. The system integrates six interdependent components: a persona development and biographical framework module; a secure virtual environment and anonymization module; a persona-associated phone number module and a multi-layered email infrastructure module operating in parallel as authentication resources to provide account verification and redundancy across multiple providers; a social media and digital identity deployment module; and a delivery and ongoing persona management module. The components operate sequentially, with the persona-associated phone number and multi-layered email infrastructure operating in parallel within the Security and Realism Layer, each building upon the preceding to ensure a cohesive, operationally secure, and credible digital identity. The system can operate as a managed service where a customer receives access credentials for email and social media accounts, together with a persona dossier and optional ongoing persona management.

### CROSS-REFERENCE TO RELATED APPLICATION

This non-provisional utility patent application claims priority to U.S. Provisional Patent Application Ser. No. 63/782,651, filed Apr. 3, 2025, entitled “Secure Digital Identity Management System for Creating and Maintaining Non-Attributable Online Personas,” the entire disclosure of which is incorporated herein by reference.

### FIELD OF THE INVENTION

The present invention relates generally to digital identity management systems, and more particularly to a structured, multi-component system for creating, configuring, and maintaining secure, non-attributable online personas for use in cybersecurity operations, intelligence research, and covert investigations.

### BACKGROUND OF THE INVENTION

In cybersecurity, intelligence operations, and covert investigations, maintaining secure, non-attributable online personas is essential for avoiding detection and ensuring operational security. Individuals and organizations operating in these fields often require digital identities that are credible, persistent, and insulated from attribution to any real-world operator.

Traditional methods for creating and managing non-attributable digital identities are manual, time-intensive, and prone to detection by platform security measures. Such methods frequently rely on piecemeal approaches—for example, using temporary email accounts, randomly generated profile details, and inconsistent online behavior—that can trigger platform security algorithms and lead to account suspension or operator exposure. These fragmented approaches also lack a systematic way to ensure continuity, making it difficult to sustain long-term operational security.

Existing tools and software typically address only isolated aspects of the problem. Commercial Virtual Private Networks (VPNs) and privacy-focused browsers, such as Tor-based solutions, offer a degree of anonymization but do not assist in the structured creation of non-attributable digital identities. Disposable email services and virtual phone number providers offer temporary solutions but lack the depth, redundancy, and strategic integration needed for persona sustainability. Social media management platforms are generally designed for marketing purposes and do not incorporate operational security measures. Anonymity-focused operating systems and sandboxed Virtual Machines provide a degree of isolation but do not facilitate the creation of realistic personas tailored for long-term credibility. Traditional intelligence (HUMINT/OSINT) tradecraft methodologies involve manual persona creation but lack a standardized digital infrastructure, making them less efficient and harder to scale.

Accordingly, there exists a need in the art for a comprehensive, structured, and repeatable end-to-end system that integrates persona development, secure virtual environments, verified communication channels, and behavioral modeling into a unified digital identity management framework. The present invention satisfies this need.

### SUMMARY OF THE INVENTION

The present invention provides a secure digital identity management system, referred to herein as the “System,” for creating and maintaining non-attributable online personas. The System integrates encryption, anonymization techniques, and behavioral modeling to generate and sustain credible digital identities for use in cybersecurity operations, intelligence research, and covert investigations.

In a preferred embodiment, the System comprises six primary, interdependent components that operate sequentially and in conjunction with one another:
a Persona Development and Biographical Framework module;
a Secure Virtual Environment and Anonymization module;
a Persona-Associated Phone Number module;
a Multi-Layered Email Infrastructure module;
a Social Media and Digital Identity Deployment module; and
a Delivery and Ongoing Persona Management module

The System provides structured workflows for setting up secure email accounts, social media profiles, and other digital identifiers while continuously adapting to evolving security challenges. By streamlining persona management, the System enhances operational efficiency, reduces exposure risk, and ensures long-term operational viability.

In one aspect, the present invention provides a method for creating and maintaining a non-attributable online persona, comprising the steps of defining a persona profile and biographical framework; establishing a secure virtual operating environment comprising at least a Virtual Machine (VM) and a Virtual Private Network (VPN) aligned with the persona profile; provisioning authentication resources for account verification purposes; creating a multi-layered email infrastructure using the secure virtual environment and the authentication resources; and deploying social media and additional digital identity accounts using the authentication resources and the persona profile.

In another aspect, the present invention provides a system for delivering a fully developed, non-attributable online persona as a service to a customer, comprising means for receiving persona requirements from the customer; means for creating and configuring the persona's digital infrastructure; and means for delivering access credentials and a persona dossier to the customer, with optional ongoing persona management services.

These and other features and advantages of the present invention will become better understood with reference to the following description of the drawings and the detailed description of the preferred embodiments.

### BRIEF DESCRIPTION OF THE DRAWINGS

The accompanying drawings, which are incorporated herein and form a part of the specification, illustrate preferred embodiments of the present invention and, together with the description, serve to explain the principles of the invention. In the drawings:

FIG. 1 is a high-level block diagram illustrating the primary components and sequential workflow of the secure digital identity management system in accordance with a preferred embodiment of the present invention; and

FIG. 2 is a flowchart illustrating the steps of creating and deploying a non-attributable online persona using the secure digital identity management system of the present invention, including the persona development, secure virtual environment, email infrastructure, and social media deployment stages, the authentication resources and security and realism layers associated therewith, and the resulting operational digital persona.

### DETAILED DESCRIPTION OF THE INVENTION

The following detailed description is of presently contemplated modes of carrying out exemplary embodiments of the invention. The description is not to be taken in a limiting sense but is made merely for the purpose of illustrating the general principles of the invention, since the scope of the invention is best defined by the appended claims. Variations of the exemplary embodiments described herein will be apparent to persons of ordinary skill in the art, and such variations are within the scope of the invention.

Referring now to the drawings, wherein like reference numerals designate like or corresponding parts throughout the several views, preferred embodiments of the present invention will be described.

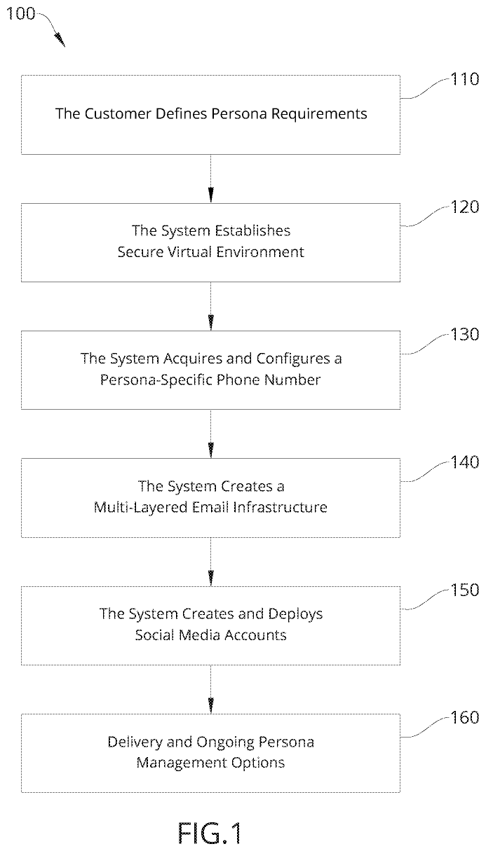

FIG. 1 is a high-level block diagram illustrating the primary components of the secure digital identity management system (100) and the sequential relationship among those components. As shown in FIG. 1, the System (100) comprises six primary components arranged in a top-to-bottom sequential flow:
the Customer/Operator Persona Requirements component (110); the Secure Virtual Environment component (120);
the Persona-Associated Phone Number component (130);
the Multi-Layered Email Infrastructure component (140);
the Social Media and Digital Identity Deployment component (150); and
the Delivery and Ongoing Persona Management component (160).

Each component is described in turn below.

Component 110—Customer/Operator Persona Requirements. Reference numeral 110 in FIG. 1 designates the first and foundational component of the System, in which a customer or operator defines the requirements and specifications for the desired online persona. This component encompasses the collection of information regarding the intended use case, the desired personal characteristics of the persona, and the level of operational depth and complexity required. The information gathered at component 110 serves as the input that drives the configuration of all downstream components of the System. Without a well-defined and internally consistent persona profile at this stage, the credibility and longevity of the resulting digital identity would be compromised.

Component 120—Secure Virtual Environment and Anonymization. Reference numeral 120 in FIG. 1 designates the Secure Virtual Environment and Anonymization component. This component establishes the technical infrastructure within which the persona will operate, including a dedicated Virtual Machine (VM) that isolates all persona-related activities from the operator's real-world identity, and a Virtual Private Network (VPN) configured to align the persona's apparent geographic location and online behavior with the biographical profile established in component 110. Component 120 provides the secure digital environment within which all subsequent account creation and identity deployment activities are conducted.

Component 130—Persona-associated Phone Number. Reference numeral 130 in FIG. 1 designates the Persona-Associated Phone Number component. This component provides a unique, dedicated phone number associated with the persona for use in authentication and verification of digital accounts. The phone number serves as one of two parallel authentication resources, together with the Multi-Layered Email Infrastructure of component 140, that support the creation and verification of email and social media accounts in components 140 and 150, respectively, with either or both resources employed depending on the authentication requirements of the target platform.

Component 140—Multi-Layered Email Infrastructure. Reference numeral 140 in FIG. 1 designates the Multi-Layered Email Infrastructure component. This component establishes a structured network of email accounts for the persona, created within the secure virtual environment of component 120 and, where a persona-associated phone number has been provisioned as part of the authentication resources, authenticated using the phone number of component 130. The email infrastructure provides at least a primary account for core digital identity purposes and may include secondary and backup accounts distributed across multiple email service providers for redundancy and resilience. As shown by the sequential flow in FIG. 1, component 140 functions as the backbone of the persona's digital identity and provides the account authentication support on which the social media deployment of component 150 depends.

Component 150—Social Media and Digital Identity Deployment. Reference numeral 150 in FIG. 1 designates the Social Media and Digital Identity Deployment component. This component represents the public-facing stage of the persona creation process, in which social media accounts and other online profiles are created and configured using the biographical framework from component 110, the secure infrastructure from component 120, and at least one of the authentication resources comprising the phone number from component 130 and the email accounts from component 140, with either or both resources employed depending on the authentication requirements of the target platform. Profile content, behavioral patterns, and account settings are configured at component 150 to reflect the persona's defined characteristics and to ensure credibility within the intended online communities. In alternative embodiments, component 150 may encompass deployment across a variety of social media platforms, online forums, professional networking sites, and other digital communities.

Component 160—Delivery and Ongoing Persona Management. Reference numeral 160 in FIG. 1 designates the Delivery and Ongoing Persona Management component. This component represents the final stage of the System as depicted in FIG. 1, in which the fully developed digital persona is delivered to the customer or operator. Delivery includes provision of access credentials for all accounts and platforms established in components 140 and 150, together with a persona dossier comprising the biographical backstory, behavioral guidelines, and operational best practices. In certain embodiments, component 160 also encompasses optional ongoing maintenance services, through which persona accounts may be monitored, updated, recovered, or refreshed as needed to maintain operational security and persona credibility over time.

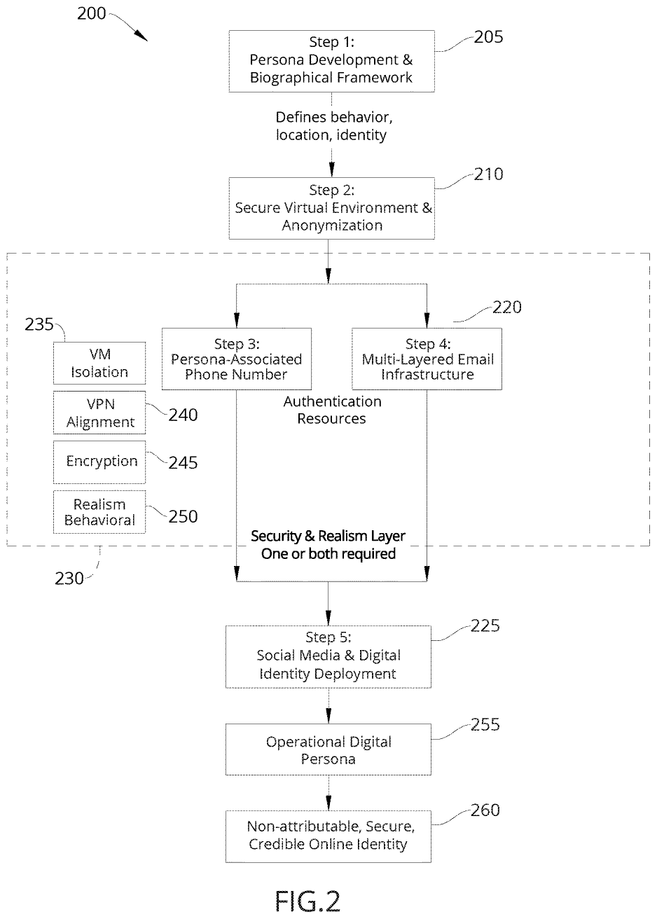

As illustrated in FIG. 1, the six components (110-160) of the System are arranged in a sequential flow that reflects the order in which each element of the persona is created, configured, and delivered. Each component receives inputs from, and provides outputs to, the adjacent components in the sequence, forming a structured and methodical pipeline for the end-to-end creation and deployment of a non-attributable online persona. The high-level block diagram of FIG. 1 thus captures the overall architecture and workflow of the System at a component level, while the more detailed process-step relationships among those components are illustrated in FIG. 2, described below.

FIG. 2 is a detailed flowchart illustrating the step-by-step process by which the System creates and deploys a non-attributable online persona. Reference numeral 200 in FIG. 2 designates the overall system process flow. As shown in FIG. 2, the process comprises five steps, four of which—comprising Step 1 (205), Step 2 (210), and the Authentication Resources grouping of Step 3 and Step 4 (220)—are situated within and supported by a Security and Realism Layer (230) that underlies the infrastructure creation stages of the process. The Authentication Resources, depicted in FIG. 2 as operating in parallel within the Security and Realism Layer (230), comprise a persona-associated phone number and a multi-layered email infrastructure (220), together providing the authentication credentials and resources that support account registration and verification for the social media deployment step (225). The social media and digital identity deployment step (225) draws upon all prior steps and supporting elements to produce an Operational Digital Persona (255), which culminates in a Non-attributable, Secure, Credible Online Identity (260) reflecting the properties conferred upon the persona by the sequential execution of all prior steps. Each step and supporting element of FIG. 2 is described in detail below.

Step 1—Persona Development and Biographical Framework (205). Reference numeral 205 in FIG. 2 designates the first process step, identified in the flowchart as Step 1: Persona Development and Biographical Framework. As depicted in FIG. 2, reference numeral 205 represents the foundational entry point of the System process, establishing the biographical framework, behavioral parameters, and identity characteristics upon which all subsequent steps depend. At this step, the customer or operator may specify the intended use case (e.g., cybersecurity research, covert investigations, intelligence gathering), desired personal characteristics (e.g., name, age, geographic location, profession, niche interests), the level of depth and complexity required (e.g., short-term operational use versus a long-term embedded persona), and behavioral guidelines to ensure the persona fits naturally within its intended online community.

As shown by the flow of FIG. 2, reference numeral 205 designates the first point of entry into the Security and Realism Layer (230), which underlies all subsequent infrastructure creation steps. The biographical framework established at reference numeral 205 defines the behavior, location, and identity parameters that propagate through and inform the configuration of every downstream step in the process, including the Secure Virtual Environment and Anonymization (210), the Authentication Resources comprising the persona-associated phone number and Multi-Layered Email Infrastructure (220), and the Social Media and Digital Identity Deployment (225). The accuracy and depth of the biographical framework at this step bears directly on the credibility and longevity of the resulting Operational Digital Persona (255).

Step 2—Secure Virtual Environment and Anonymization (210); VM Isolation (235); VPN Alignment (240); Encryption (245); Behavioral Realism (250). Reference numeral 210 in FIG. 2 designates the second process step, identified in the flowchart as Step 2: Secure Virtual Environment and Anonymization. As depicted in FIG. 2, step 210 comprises four primary sub-elements: VM Isolation (235), VPN Alignment (240), Encryption (245), and Behavioral Realism (250), all of which operate as part of the Security and Realism Layer (230).

VM Isolation (235), as depicted in FIG. 2, involves the creation of a dedicated Virtual Machine (VM) that isolates the persona's activities from the operator's real-world identity and computing environment. The VM provides a compartmentalized operating context in which all persona-related activities are conducted, preventing cross-contamination with the operator's personal or organizational digital footprint.

VPN Alignment (240), as depicted in FIG. 2, involves the configuration of a Virtual Private Network (VPN) tailored to match the persona's biographical details as established at reference numeral 205. The VPN is configured so that all outbound network traffic associated with the persona appears to originate from a geographic location consistent with the persona's intended backstory, ensuring that the persona's online interactions present an internally consistent geographic and behavioral profile.

Also associated with step 210 in FIG. 2 are Encryption (245) and Behavioral Realism (250), both of which are components of the Security and Realism Layer (230). Encryption (245) refers to the application of encryption protocols to communications and stored data within the secure virtual environment, protecting persona-related information from unauthorized access or interception. Behavioral Realism (250) refers to the configuration of the virtual environment and associated tools to replicate realistic human browsing and interaction patterns, reducing the risk of automated detection by platform security measures. A hardened web browser configuration may also be employed at step 210 to prevent device fingerprinting, tracking, and information leakage. In alternative embodiments, additional anonymization layers may be employed, including but not limited to privacy-focused operating systems or layered VPN configurations.

As depicted by the flow of FIG. 2, the secure virtual environment established at step 210 provides the foundational digital context within which all subsequent persona-related activities are conducted, including the email account creation of reference number 220 and the social media deployment of reference number 225.

Steps 3 and 4—Authentication Resources: Persona-Associated Phone Number and Multi-Layered Email Infrastructure (220). The Authentication Resources depicted in FIG. 2 provide the authentication credentials and supporting infrastructure required to verify and register digital accounts associated with the persona. The Authentication Resources comprise two components operating in parallel within the Security and Realism Layer (230): a Persona-Associated Phone Number (Step 3) and a Multi-Layered Email Infrastructure (220) (Step 4). Together, these components provide the authentication inputs that support account creation and verification for the Social Media and Digital Identity Deployment (225). Either component alone may be sufficient to support account registration depending on the authentication requirements of the target platform; in most operational contexts, both are employed together to maximize platform compatibility, redundancy, and persona resilience.

Persona-Associated Phone Number (Step 3). The persona-associated phone number component of the Authentication Resources provides a unique, dedicated phone number associated with the persona for use in authentication and verification of digital accounts. The phone number is obtained and configured based on the complexity and operational requirements of the persona as established at reference number 205. Such resources may include a virtual number (e.g., a Voice over IP (VoIP) number or similar internet-based telephony service) for lower-risk, shorter-duration operations, or a physical SIM card with active network service for higher-credibility, longer-duration personas. Multiple phone numbers may be provisioned for personas requiring multi-platform verification. The authentication resources are configured so that associated regional and identity attributes are consistent with the persona's geographic profile and biographical framework as established at reference number 205.

Multi-Layered Email Infrastructure (220) (Step 4). Reference numeral 220 in FIG. 2 designates the Multi-Layered Email Infrastructure, forming the second of the two parallel components of the Authentication Resources within the Security and Realism Layer (230). At reference number 220, each email account is created using the secure Virtual Machine and VPN established at reference number 210 and, where a persona-associated phone number has been provisioned as part of the Authentication Resources, verified using that phone number. The email infrastructure comprises at least a primary email account serving as the core digital identity of the persona, and may additionally include secondary and backup email accounts for account recovery and multi-platform redundancy. Distributing accounts across multiple email service providers reduces the risk of detection or mass deactivation and enhances the overall resilience of the persona's digital infrastructure.

As depicted in FIG. 2, the Authentication Resources—comprising the persona-associated phone number and the Multi-Layered Email Infrastructure (220)—together serve as the authentication bridge linking the secure virtual environment (210) to the persona's public-facing digital presence established at the Social Media and Digital Identity Deployment (225), ensuring that all account creation activities are conducted using credentials that are consistent with the persona's profile and non-attributable to the real operator.

Step 5—Social Media and Digital Identity Deployment (225). Reference numeral 225 in FIG. 2 designates the fifth and final process step, identified in the flowchart as Step 5: Social Media and Digital Identity Deployment. As depicted in FIG. 2, this step involves the creation and configuration of social media accounts and other public-facing digital identities for the persona, drawing upon all prior steps of the process.

At reference number 225, social media accounts are created using the persona's biographical framework from reference number 205, the secure virtual environment from reference number 210, and at least one of the authentication resources comprising the persona-associated phone number and the Multi-Layered Email Infrastructure (220). Profile details—including names, biographies, profile images, and behavioral patterns—are configured to reflect the persona's defined interests, affiliations, and background, ensuring credibility within the online communities where the persona will operate.

As shown in FIG. 2, reference number 225 draws upon the Security and Realism Layer (230), established in the prior steps of the process, which ensures that each account is configured securely and in a manner consistent with realistic human behavioral patterns. In alternative embodiments, the System supports deployment across a variety of social media platforms, online forums, professional networking sites, and other digital communities.

Operational Digital Persona (255). Reference numeral 255 in FIG. 2 designates the Operational Digital Persona, which is the output produced upon completion of the Social Media and Digital Identity Deployment (225). As depicted in FIG. 2, the Operational Digital Persona (255) represents the fully assembled digital identity produced by the sequential execution of reference numbers 205 and 210 and the parallel Authentication Resources comprising the persona-associated phone number and Multi-Layered Email Infrastructure (220), all operating within or drawing upon the Security and Realism Layer (230). The Operational Digital Persona (255) comprises a persona biographical framework, a secure virtual operating environment, authentication resources, a multi-layered email infrastructure, and one or more social media and digital identity accounts, all configured for long-term operational use, and serves as the foundation for the Non-attributable, Secure, Credible Online Identity (260) that represents the culminating output of the System.

Security and Realism Layer (230). Reference numeral 230 in FIG. 2 designates the Security and Realism Layer, which is depicted as a cross-cutting architectural element that underlies and supports the first four steps of the process—comprising reference numeral 205, reference numeral 210, and the Authentication Resources grouping of the persona-associated phone number and Multi-Layered Email Infrastructure (220)—and informs the properties of the resulting Operational Digital Persona (255). The Security and Realism Layer (230) encompasses the technical security measures and behavioral intelligence techniques that are applied throughout the persona creation process to ensure that the Operational Digital Persona is both technically secure and convincingly realistic.

As depicted in FIG. 2, the Security and Realism Layer (230) integrates VM Isolation (235) to compartmentalize persona activities; VPN Alignment (240) to ensure geographic consistency; Encryption (245) to protect persona-related communications and data; and Behavioral Realism (250) to replicate authentic human interaction patterns. These elements work in concert across all process steps to reduce the risk of automated detection by platform security systems and to ensure non-attribution of the persona to the real operator. The Security and Realism Layer (230) also operates in conjunction with the Authentication Resources, which supply the authentication credentials used to register and verify the email infrastructure (220) and the Social Media and Digital Identity Deployment (225) accounts, providing a coherent and internally consistent authentication chain for the persona's digital infrastructure.

As illustrated in FIG. 2, the five-step process—comprising reference numerals 205, 210, the Authentication Resources grouping of the persona-associated phone number and Multi-Layered Email Infrastructure (220), and the Social Media and Digital Identity Deployment (225)—operates within or draws upon the Security and Realism Layer (230) to produce the Operational Digital Persona (255). The first four steps operate within the Security and Realism Layer (230), with reference numerals 205 and 210 executing sequentially and the Authentication Resources comprising the persona-associated phone number and Multi-Layered Email Infrastructure (220) operating in parallel, before culminating in the Social Media and Digital Identity Deployment (225) which draws upon all prior steps and supporting elements. The flowchart of FIG. 2 thus provides a detailed depiction of the process-level operation of the System, complementing the component-level architecture depicted in FIG. 1.

The components depicted in FIG. 1 (110-160) and the process steps depicted in FIG. 2—comprising reference numerals 205, 210, the Authentication Resources grouping of the persona-associated phone number and Multi-Layered Email Infrastructure (220), and the Social Media and Digital Identity Deployment (225)—correspond to one another and together describe the complete architecture and operation of the System. FIG. 1 presents the System at the component level, illustrating the six primary building blocks of the System and the high-level sequential relationship among them. FIG. 2 presents the System at the process level, illustrating the detailed steps by which each component is implemented and the security, realism, and authentication mechanisms that support each step. Taken together, FIGS. 1 and 2 provide a comprehensive view of both the structural architecture and the operational process flow of the secure digital identity management system.

It should be understood that the foregoing relates to exemplary embodiments of the invention and that modifications may be made without departing from the spirit and scope of the invention as set forth in the following claims.

What is claimed is:

1. A computer-implemented system for creating and maintaining a non-attributable online persona, the system comprising: a persona development module configured to receive persona profile information defining at least a biographical backstory, an intended geographic location, and behavioral characteristics for the persona; a secure virtual environment module configured to establish a virtual machine that isolates persona-related activities from an operator's computing environment, and a virtual private network configured to present a geographic location consistent with the biographical backstory; a security and realism layer operatively associated with the secure virtual environment module, the security and realism layer comprising an encryption component configured to protect persona-related communications and data, and a behavioral realism component configured to replicate human interaction patterns to reduce automated detection; an authentication resources module comprising two parallel components operating within the security and realism layer: a phone number provisioning component configured to provide at least one dedicated phone number as an authentication credential for registration and verification of digital accounts associated with the persona, and an email infrastructure component configured to create a plurality of email accounts using the virtual machine and the virtual private network, wherein the plurality of email accounts are verified using the dedicated phone number provided by the phone number provisioning component, and wherein either or both components may be employed to support account registration depending on the authentication requirements of the target platform; and a social media deployment module configured to create and configure one or more social media accounts for the persona using the persona profile information, the secure virtual environment, and at least one of the authentication resources comprising the persona-associated phone number and the plurality of email accounts, wherein the social media deployment module draws upon the security and realism layer to ensure that each account is configured securely and in a manner consistent with realistic human behavioral patterns.

2. The system of claim 1, wherein the secure virtual environment module further comprises a hardened browser configuration configured to prevent device fingerprinting, tracking, and information leakage.

3. The system of claim 1, wherein the phone number provisioning component of the authentication resources module is configured to provide at least one of a virtual Voice over IP (VoIP) number and a physical SIM-based number as an authentication credential, selected based on an operational complexity requirement of the persona.

4. The system of claim 1, wherein the email infrastructure component of the authentication resources module creates a plurality of email accounts comprising at least a primary email account and at least one secondary backup email account, the email accounts being distributed across a plurality of email service providers.

5. The system of claim 1, wherein the social media deployment module is further configured to generate profile content comprising at least one of a profile biography, behavioral activity patterns, and profile images, wherein the profile content is consistent with the persona profile information.

6. The system of claim 1, further comprising a persona delivery module configured to provide a customer with access credentials for the plurality of email accounts and the one or more social media accounts, and a persona dossier comprising behavioral guidelines and operational best practices for use of the persona, wherein any persona-associated phone number provisioned as part of the authentication resources is configured and maintained as operational infrastructure for account registration and verification purposes and is not required to be delivered to the customer as a credential.

7. The system of claim 6, further comprising an ongoing persona management module configured to at least one of monitor, update, and recover persona accounts over time.

8. A method for creating a non-attributable online persona, the method comprising: defining a persona profile comprising biographical information, a geographic location, and behavioral characteristics; establishing a secure virtual operating environment comprising a virtual machine configured to isolate persona-related activities from an operator's computing environment, and a virtual private network configured to align an apparent geographic location of the persona with the geographic location defined in the persona profile; applying a security and realism layer throughout the method, comprising encrypting persona-related communications and data, and configuring behavioral realism parameters to replicate human interaction patterns; provisioning authentication resources comprising two parallel components: a persona-associated phone number selected based on an operational complexity requirement of the persona, and a plurality of email accounts created via the secure virtual operating environment and verified using the persona-associated phone number, wherein either or both components may be employed to support account registration depending on the authentication requirements of the target platform; deploying one or more social media accounts using the persona profile and at least one of the authentication resources comprising the persona-associated phone number and the plurality of email accounts, wherein the social media accounts include content consistent with the biographical information and behavioral characteristics; and producing an operational digital persona comprising the secure virtual operating environment, the authentication resources comprising the persona-associated phone number and the plurality of email accounts, and the one or more social media accounts, the operational digital persona being non-attributable to the operator.

9. The method of claim 8, wherein defining the persona profile further comprises specifying at least one of an intended use case, a persona age, a persona profession, and a set of persona niche interests.

10. The method of claim 8, wherein establishing the secure virtual operating environment further comprises configuring a hardened browser to prevent device fingerprinting, tracking, and information leakage.

11. The method of claim 8, wherein the email accounts of the authentication resources comprise at least one primary email account and at least one secondary backup email account distributed across a plurality of email service providers.

12. The method of claim 8, further comprising delivering access credentials for the plurality of email accounts and the one or more social media accounts to a customer, together with a persona dossier comprising behavioral guidelines for operation of the persona, wherein any persona-associated phone number provisioned as part of the authentication resources is configured and maintained as operational infrastructure for account registration and verification purposes and is not required to be delivered to the customer as a credential.

13. The method of claim 12, further comprising providing ongoing persona management services comprising at least one of monitoring persona account activity, updating persona account content, and recovering compromised persona accounts.

14. A computer-implemented system for providing a non-attributable online persona as a managed service to a customer, the system comprising: a customer interface module configured to receive persona requirements from the customer, the persona requirements comprising at least an intended use case and desired persona characteristics; a persona development module configured to generate a persona biographical framework based on the persona requirements, the persona biographical framework comprising a backstory, an intended geographic location, and behavioral parameters; a secure virtual environment module configured to establish a virtual machine and a virtual private network in accordance with the persona biographical framework, and to apply encryption to persona-related communications and data; an authentication resources module comprising two parallel components: a phone number provisioning component configured to provision at least one dedicated phone number as an authentication credential for verification of digital accounts associated with the persona, and an email infrastructure component configured to create a plurality of email accounts for the persona using the virtual machine and the virtual private network, wherein the plurality of email accounts are verified using the dedicated phone number provided by the phone number provisioning component, and wherein either or both components may be employed to support account registration depending on the authentication requirements of the target platform; a social media deployment module configured to create and configure one or more social media accounts for the persona using the persona biographical framework and at least one of the authentication resources comprising the persona-associated phone number and the plurality of email accounts; and a persona delivery module configured to deliver to the customer access credentials for the plurality of email accounts and the one or more social media accounts, together with a persona dossier comprising the biographical framework, behavioral guidelines, and operational best practices, wherein any persona-associated phone number provisioned as part of the authentication resources is configured and maintained as operational infrastructure for account registration and verification purposes and is not required to be delivered to the customer as a credential.

15. The system of claim 14, wherein the secure virtual environment module further comprises a hardened browser configuration configured to prevent device fingerprinting and tracking.

16. The system of claim 14, wherein the phone number provisioning component of the authentication resources module is further configured to select at least one of a virtual Voice over IP (VoIP) number and a physical SIM-based number as an authentication credential based on operational requirements of the persona.

17. The system of claim 14, wherein the email infrastructure component of the authentication resources module is further configured to distribute the plurality of email accounts across a plurality of email service providers to provide redundancy.

18. The system of claim 14, wherein the social media deployment module is further configured to generate profile content comprising at least one of a profile biography, profile images, and behavioral activity patterns, wherein the profile content is consistent with the persona biographical framework.

19. The system of claim 14, further comprising an ongoing persona management module configured to at least one of monitor, update, and recover persona accounts on behalf of the customer after delivery.

20. The system of claim 14, wherein the persona development module is further configured to apply behavioral realism parameters to the persona biographical framework to replicate human interaction patterns and reduce automated detection by online platform security systems.
